(19) United States
(12) Patent Application Publication
(10) Pub. No.: US 2004/0070327 A1
(43) Pub. Date: Apr. 15, 2004

(54) Alumino earth-alkali silicate glasses with high thermal capacity for light bulbs and use thereof

(76) Inventors: Hannelore Bergmann, Weisswasser (DE); Hans-Jurgen Bergmann, Weisswasser (DE)

Correspondence Address: GUDRUN E. HUCKETT, LONSSTR. 53, WUPPERTAL, 42289, DE

(21) Appl. No.: 10/275,375

(22) PCT Filed: May 4, 2001
(86) PCT No.: PCT/DE01/01725

(30) Foreign Application Priority Data
May 5, 2000 (DE) 100 22 769.4

(51) Int. Cl. H01J 5/04

(52) U.S. Cl. 313/317

(57) ABSTRACT

The invention relates to alumino earth-alkali silicate glasses for molybdenum glass fusions in the form of light bulbs, as the outer shell for lamps, in particular for lamps with regenerative halogen cycles at bulb temperatures of from over 550° C. up to 700° C. Surprisingly and contrary to the current expectation it was found that alumino earth-alkali silicate glasses with a water content of 0.025 to 0.042 wt. % meet the requirements for halogen lamp glass and do not display any disadvantages due to the presence of the above impurity for the halogen cycle process at bulb temperatures of between 550 and 700° C. In glasses with a water content of from 0.025 to 0.042 wt. % the water present does not act as an impurity in the sense that it does not disturb the equilibrium between formation and decomposition of tungsten halides. A blackening of the inner surface of the bulb does not occur, or not a greater degree when compared with bulb glasses with a considerably lower water content.

The invention relates to alumino earth-alkali silicate glasses for molybdenum-glass fusions in the form of light bulbs as the outer casing for lamps, in particular, for lamps with regenerative halogen cycle and bulb temperatures of from above 550° C. up to 700° C.

It is known that the stability of the regenerative halogen cycle in halogen lamps is the prerequisite for reaching the target lamp life of a halogen lamp. Decisive for this is that the equilibrium between formation and decomposition of tungsten halides is maintained. Disruptions of the halogen cycle, inter alia, can be caused by smallest amounts of contaminations in the glass as well as in the filament material or the feed-through sleeve material. These contaminations, inter alia, can weaken the halogen cycle as a result of the high lamp temperatures as well as the energy-rich radiation of the tungsten filament so that metallic tungsten will form a black precipitate on the inner side of the bulb. This causes a weakening of the lamp efficiency and light translucence. It is a well known fact that particularly alkali ions have such a disruptive effect on the halogen cycle. For this reason, industrial scale halogen lamp glasses are practically free of alkali, which recently has resulted in alkali oxide contents (R₂O) of <0.03% by weight, inasmuch as no stabilizing components partially compensate their effect. In addition to the negative effect of the alkali ions, other components such as H₂, OH⁻, CO and CO₂ are said to have an aggressive effect and to cause disruptions of the cycling process.

EP 0 913 265 and DE 197 47 354 therefore limit the water contents to <0.02% by weight in order to prevent blackening of the lamp.

EP 0 913 366 and DE 197 58 481 limit the water contents also to <0.02% by weight because the water or the hydrogen ions are also said to cause a disruptive effect on the halogen cycling process.

WO 99/14794 limits the water contents also to <0.02% by weight.

U.S. Pat. No. 4,163,171 discloses a glass composition which is atypical for halogen lamp glasses (SiO₂ 50%, P₂O₅ 4.8%, and Al₂O₃ 19.2%) wherein the CO and alkali contents are practically zero and the water contents is limited to less than 0.03% by weight. Glasses of this type of composition however have practically not been used as halogen lamp glasses.

Numerous hart glasses which have been, and are being used, for halogen lamps, for example, glasses 180 made by General Electric; 1720, 1724, and 1725 made by Corning; as well as 8252 and 8253 made by a Schott, have water contents under 0.025% by weight, partially under 0.02% by weight. These glasses are within the composition range according to Table 1.

TABLE 1

| Oxides | % by weight |
|---|---|
| SiO₂ | 56.4-63.4 |
| Al₂O₃ | 14.6-16.7 |
| B₂O₃ | 0-5.0 |
| BaO | 7.5-17.0 |
| CaO | 6.7-12.7 |
| MgO | 0-8.2 |
| SrO | 0-0.3 |
| ZrO₂ | 0-1.1 |
| TiO₂ | 0-0.2 |
| Na₂O | 0.02-0.05 |
| K₂O | 0.01-0.02 |
| Fe₂O₃ | 0.03-0.05 |

The typical compositions of halogen lamp glasses in patents are within the range of Table 2.

TABLE 2

| Oxides | % by weight |
|---|---|
| SiO₂ | 52-71 |
| Al₂O₃ | 13-25 |
| B₂O₃ | 0-6.5 |
| BaO | 0-17 |
| CaO | 3.5-21 |
| MgO | 0-8.3 |
| SrO | 0-10 |
| ZrO₂ | 0-5.5 |
| R₂O | 0-0.08 (1.2) |
| TiO₂ | 0-1 |
| Water | <0.025 |

Observing these limits, in particular of the low water contents, poses significant requirements with regard to the employed raw materials as well as the glass melting process, such as, for example:

use of dried raw materials and refuse glass;

water-free raw materials;

increased technical and thus financial expenditure for the apparatus technology and operation of the glass melting apparatus for obtaining melting temperatures above 1,600° C. with a low partial water vapor pressure above the molten glass.

There presently exists, and there will exist in the future, a significant demand for glasses for halogen lamps.

The object of the invention resides in providing glasses which can be produced economically more advantageously and which enable their use in lamps, in particular, in halogen lamps.

Surprisingly, and contrary to the present knowledge, it was found that alumino earth-alkali silicate glasses with a water contents of 0.025 to 0.042% by weight fulfill the requirements in regard to halogen lamp glass and do not exhibit disadvantages from these contaminations in regard to the halogen cycling process at bulb temperatures between 550 and 700° C. In glasses having a water contents of 0.025 to 0.042% by weight, the water contents does not act as a contamination in the sense of disturbing the equilibrium between formation and decomposition of tungsten halides. Blackening of the inner surface of the bulb of the lamp does not occur or not to a greater degree compared to bulb glasses with a significantly reduced water contents.

The invention comprises all alumino earth-alkali silicate glasses which have the required properties for lamp bulbs used in tungsten halogen lamps, such as

the application of molybdenum as feed-through sleeve material and the compressive strains to be achieved in the glass by means of the thermal expansion coefficient;

the high thermal softening of the glass which limits the upper lamp temperature:

| | |
|---|---|
| α_{20-400° C.} | 4.4-4.8* 10⁻⁶ K⁻¹ |
| T ₛₜᵣ | 665-730° C. |
| T _{soft} | 925-1020° C. |

In a preferred embodiment of the invention, the alumino earth-alkali silicate glass has the following composition (% by weight):

| | |
|---|---|
| SiO₂ | 55.0-62.5 |
| Al₂O₃ | 14.5-18.5 |
| B₂O₃ | 0-4.0 |
| BaO | 7.5-17.0 |
| CaO | 6.5-13.5 |
| MgO | 0-5.5 |
| SrO | 0-2.0 |
| ZrO₂ | 0-1.5 |
| TiO₂ | 0-1.0 |
| ZnO | 0-0.5 |
| CeO₂ | 0-0.3 |
| R₂O | <0.03 |
| H₂O | 0.025-0.042 |

The glasses according to the invention enable their use in halogen lamps in temperature ranges of the bulb between 550 and 700° C., do not exhibit the disadvantages of contaminations, for example, water, for the halogen cycle in comparison to water-poor glasses, and, in regard to manufacture, have economic advantages relative to the marketable glasses of the prior art.

Experiments in regard to the effect of the water contents on alumino earth-alkali silicate glasses show surprisingly the following results:

reduction of the liquidus temperature by, on average, 10 to 15 K in the composition range in comparison to the processing temperature in the tube forming range;

reduction of the viscosity temperatures in the viscosity range 10^{13.0} to 10^{14.5} by, on average, 6 to 14 K while maintaining the viscosity temperatures in the processing range.

improvement of the melting behavior of the glasses in the flame during melting and fusing.

Based on these results, significant economic advantages for the industrial scale manufacture of halogen lamp glasses can be derived. These are:

use of energy-efficient melting processes for the molten glass of halogen lamp glasses, such as “oxy-fuel melter” with significant product-specific energy savings;

energy savings by lowering the melting temperatures for the molten glass with simultaneous reduction of wear on refractory material of the melting devices;

yield increase for glass tube manufacture by complete avoidance crystallization of the glasses during the tube forming step as a result of the lowering of the liquidus temperature relative to the processing temperature;

use of water-containing glass raw materials;

increase of the processing speeds in the lamp manufacture as a result of “steeper” temperature-viscosity-course of the glass.

The invention will be explained in more detail with the aid of the following embodiments.

In order to ensure a direct application, examples of glasses were melted in a glass melting vessel of a contents of 3.5 metric tons, and, subsequently, tubes were drawn. The glass melting vessel was equipped with a combination gas-oxygen or gas-air heating system so that gas-oxygen heating or gas-air heating as well as combination variants could be used for heating. In this way it was possible to vary and adjust the water contents of the glass by means of the partial pressure of the furnace atmosphere.

The employed raw materials were: quartz powder; aluminum oxide; hydrated alumina; boric acid; calcium carbonate, barium carbonate, and strontium carbonate; magnesium oxide; zirconium silicate; titanium oxide; zinc oxide; and cerium oxide. The raw materials were poor in alkali and had technical purity. Water-containing raw materials, such as aluminum hydroxide, were introduced in order to be able to control the water contents of the glasses additionally. Raw materials and refuse glass were used dried or moist.

The glass melting vessel is equipped additionally with auxiliary devices, in order to blow water vapor directly into the molten glass—a further possibility to change the water contents of the glass.

In this way it was possible to vary:

the glass composition;

the water contents; and

the melting conditions, such as melting temperatures and melting duration, within the context of the object of the invention.

The glasses were melted at temperatures between 1600 and 1660° C., refined, and homogenized. The tubes manufactured therefrom were free of flaws in the glass and matched the size required for lamp manufacture. Halogen lamps were produced from the tubes and subjected to lamp life tests. The electrode material was categorically annealed, in order to eliminate its effect on the halogen cycling process.

Glass compositions and important properties of the melted glasses (A) of the examples were compared with known water-reduced glasses (V). The comparative results are combined in Table 3.

TABLE 3
Glass Composition and Properties of the Examples A
and Comparative Examples V

| | % by | | | | | | | | | | |
|---|---|---|---|---|---|---|---|---|---|---|---|
| oxides | weight | A1 | V1 | A2 | V2 | A3 | V3 | A4 | V4 | A5 | V5 |
| SiO₂ | | 59.4 | 59.4 | 55.5 | 55.5 | 60.8 | 60.8 | 60.4 | 60.4 | 61.9 | 61.9 |
| Al₂O₃ | | 16.0 | 16.0 | 17.6 | 17.6 | 16.2 | 16.2 | 16.4 | 16.4 | 14.2 | 14.2 |
| B₂O₃ | | 1.7 | 1.7 | 4.0 | 4.0 | 0.5 | 0.5 | 1.9 | 1.9 | | |
| BaO | | 11.1 | 11.1 | 8.7 | 8.7 | 8.2 | 8.2 | 6.9 | 6.9 | 16.6 | 16.6 |
| CaO | | 9.5 | 9.5 | 7.8 | 7.8 | 12.5 | 12.5 | 11.3 | 11.3 | 6.7 | 6.7 |
| MgO | | 1.0 | 1.0 | 5.5 | 5.5 | | | 1.0 | 1.0 | | |
| SrO | | | | 0.3 | 0.3 | | | 1.2 | 1.2 | 0.2 | 0.2 |
| ZrO₂ | | 1.0 | 1.0 | 0.2 | 0.2 | 1.5 | 1.5 | 0.2 | 0.2 | | |
| TiO₂ | | 0.2 | 0.2 | 0.1 | 0.1 | | | 0.3 | 0.3 | 0.2 | 0.2 |
| ZnO | | | | 0.2 | 0.2 | | | 0.3 | 0.3 | | |
| CeO₂ | | | | | | 0.2 | 0.2 | | | 0.1 | 0.1 |
| R₂O | | 0.026 | 0.026 | 0.028 | 0.028 | 0.028 | 0.028 | 0.026 | 0.026 | 0.029 | 0.029 |
| water | | 0.039 | 0.021 | 0.041 | 0.021 | 0.040 | 0.020 | 0.033 | 0.018 | 0.039 | 0.019 |
| α | 10⁻⁶K⁻¹ | 4.50 | 4.51 | 4.44 | 4.45 | 4.55 | 4.55 | 4.43 | 4.45 | 4.61 | 4.60 |
| 20-400 | | | | | | | | | | | |
| T str | ° C. | 700 | 710 | 675 | 683 | 715 | 725 | 707 | 712 | 723 | 735 |
| T ann | ° C. | 760 | 770 | 723 | 730 | 766 | 780 | 759 | 765 | 775 | 786 |
| T soft | ° C. | 987 | 990 | 929 | 930 | 996 | 998 | 982 | 984 | 1017 | 1018 |
| T work | ° C. | 1294 | 1295 | 1198 | 1197 | 1309 | 1310 | 1291 | 1290 | 1366 | 1367 |
| T liqu | ° C. | 1181 | 1195 | 1138 | 1150 | 1225 | 1240 | 1215 | 1230 | 1190 | 1200 |
| KWG | μm/min | 8 | 12 | 18 | 25 | 14 | 16 | 12 | 13 | 5 | 8 |
| max | | | | | | | | | | | |

As can be taken from Table 3, the different glass compositions have different softening behavior relative to the maximum permissible bulb temperature in the lamp. For this reason, high-performance lamps were produced of glasses with a high softening temperatures and regular-load lamps of glasses with low softening temperature. The results of the lamp life test of the halogen lamps were evaluated with regard to blackening (spot formation on the inner surface of the bulb) and luminous flux drop. The lamp life was between 135 and 720 hours, depending on the lamp type. The results are combined in Table 4.

TABLE 4
Results of Lamp Life Test on Halogen Lamps
Luminous Flux Drop/Average of 20 lamps in %, respectively.

| A1 | V1 | A2 | V2 | A3 | V3 | A4 | V4 | A5 | V5 |
|---|---|---|---|---|---|---|---|---|---|
| 2.4 | 1.9 | 4.7 | 4.5 | 2.0 | 2.1 | 3.7 | 4.1 | 6.4 | 5.9 |

blackening/number based on 20 lamps, respectively

| | | | | | | | | | | |
|---|---|---|---|---|---|---|---|---|---|---|
| with | 0 | 0 | 3 | 2 | 0 | | 1 | 2 | 3 | 3 |
| blackening | | | minimal | minimal | | | minimal | minimal | medium | medium |
| | | | | | | | | | 2 | 1 |
| | | | | | | | | | minimal | minimal |
| without | 20 | 20 | 17 | 18 | 20 | 20 | 19 | 18 | 15 | 16 |
| blackening | | | | | | | | | | |

In order to double-check the results of the halogen lamp tests, further tests were performed:

high-vacuum degassing test in the temperature range of 900 . . . 1,600° C. for determining the gas contents of the glasses; and

determination of water release of the glass at the lower stress relief temperature Tₛₜᵣ under vacuum in comparison to the total water contents in percent (infrared spectroscopy).

The results are combined in Table 5

TABLE 5
Gas Release of the Glasses in High Vacuum in a
Temperature Range of 900 . . . and 1, 600 ° C./10^{-4 Pa}
Vᵢ - Glasses = 1 in Comparison to Aᵢ

| | A1 | V1 | A2 | V2 | A3 | V3 | A4 | V4 | A5 | V5 |
|---|---|---|---|---|---|---|---|---|---|---|
| total gas | 0.969 | 1 | 1.043 | 1 | 1.007 | 1 | 0.932 | 1 | 0.919 | 1 |
| release % | | | | | | | | | | |

Water Release of the Glasses at T str
(120 hours, 1 · 10⁻¹ mbar)

| | | | | | | | | | | |
|---|---|---|---|---|---|---|---|---|---|---|
| total | 392 | 211 | 410 | 208 | 401 | 203 | 332 | 180 | 394 | 193 |
| contents in | | | | | | | | | | |
| ppm | | | | | | | | | | |
| release: | 3 | 3 | 5 | 4 | 7 | 5 | 3 | 4 | 7 | 5 |
| ppm | | | | | | | | | | |
| % | 0.9 | 1.4 | 1.3 | 1.9 | 1.9 | 2.5 | 1.0 | 2.2 | 1.8 | 2.6 |

The results show that for absolute gas release under high vacuum as well as for the water release at Tₛₜᵣ no significant differences are present for glasses with low or high water contents. The trend of these results coincides with those of lamp life tests of the halogen lamps. The water release of glasses with a higher water contents (0.025 . . . 0.042% by weight) is not greater than for glasses with significantly lower water contents. The same holds true for the total gas release of the glasses. The results of the lamp life tests of the halogen lamps show that there is no significant difference between the use of glasses with high or less high water contents with respect to lamp life (failure, luminous flux drop, blackening). By means of the use of glasses with higher water contents and their proven suitability in the application of halogen lamps, the aforementioned economic advantages in regard to the manufacture of the glass, of the glass tubes, and the halogen lamps can be utilized completely. This relates to the glasses within the broad protected range of composition.

1. Alumino earth-alkali silicate glass for lamp bulbs of tungsten halogen incandescent lamps having a water contents of 0.025 to 0.042% by weight.

2. Alumino earth-alkali silicate glass according to claim 1, having the following glass composition (% by weight);

| | |
|---|---|
| SiO₂ | 55.0-62.5 |
| Al₂O₃ | 14.5-18.5 |
| B₂O₃ | 0-4.0 |
| BaO | 7.5-17.0 |
| CaO | 6.5-13.5 |
| MgO | 0-5.5 |
| SrO | 0-2.0 |
| ZrO₂ | 0-1.5 |
| TiO₂ | 0-1.0 |
| ZnO | 0-0.5 |
| CeO₂ | 0-0.3 |
| R₂O | <0.03 |
| H₂O | 0.025-0.042. |

3. Use of the glasses according to one of the claims 1 to 2, respectively, as a lamp bulb for tungsten halogen incandescent lamps with temperatures of above 550° C. up to 700° C.
